(19) United States
(12) Patent Application Publication
(10) Pub. No.: US 2022/0194030 A1
(43) Pub. Date: Jun. 23, 2022

(54) METHOD FOR THE REPEATED ACTIVATION OF AN ORTHODONTIC CORRECTION DEVICE

(71) Applicant: K Line Europe GmbH, Düsseldorf (DE)

(72) Inventor: Sherif Kandil, Düsseldorf (DE)

(73) Assignee: K Line Europe GmbH, Düsseldorf (DE)

(21) Appl. No.: 17/603,041

(22) PCT Filed: Apr. 14, 2020
(86) PCT No.: PCT/EP2020/060430

§ 371 Date: Oct. 12, 2021

(30) Foreign Application Priority Data
Apr. 12, 2019 (DE) 10 2019 109 807.6

(51) Int. Cl. B29C 71/02; H05B 1/02

(52) U.S. Cl. CPC B29C 71/02; A61C 7/08; H05B 1/025

(57) ABSTRACT

The invention relates to a method for the repeated activation of orthodontic correction devices with a known critical temperature (Tkrit) and a glass transition temperature (Tg) lying above the critical temperature. In the method according to the invention, in order to guarantee gentle repeated activation, an orthodontic correction device is heated to a temperature that lies above the critical temperature but below the known glass transition temperature. The invention also relates to a device for performing the method.

### BACKGROUND OF THE INVENTION

The invention relates to a method for the repeated activation of an orthodontic correction device and a device for performing the method.

From a first given shape, a shape memory polymer (SMP) can alter its first given shape to another second given shape by means of an activation, i.e., a stimulus, e.g., a thermal, chemical or physical stimulus. Hydrogels and shape memory alloys (SMAs) have similar properties. A combination of the aforementioned materials that modify their shape under the action of a stimulus is frequently deployed. In particular, heat, that is to say a temperature increase, is deployed for the activation. The aforementioned materials mostly have a glass transition temperature (Tg). If said glass transition temperature is achieved as a consequence of heat supply, the change occurs from the first given shape to the second given shape. In order to trigger a change in shape by means of a temperature increase, it is sufficient to exceed a critical temperature (Tkrit). This is explained, e.g., in US 2006/0154195 A1. This property of the change in shape as a consequence of a temperature increase is increasingly also being utilized for orthodontic correction devices (dental aligners) that are manufactured from a SMP, a hydrogel or a SMA. During a tooth correction it is often necessary for the orthodontic correction device to alter its shape multiple times, e.g., in order to alter the position of a tooth over a greater distance. A repeated activation puts a strain on the material because it leads to a decomposition of the SMP, hydrogel or SMA.

### SUMMARY OF THE INVENTION

It is therefore the object of the invention to propose a gentle method for the repeated activation of an orthodontic correction device.

This object is achieved with a method for the repeated activation of orthodontic correction devices with a known critical temperature (Tkrit) and a known glass transition temperature (Tg), in which an orthodontic correction device is heated to a temperature that lies above the critical temperature but below the known glass transition temperature. The critical temperature and the glass transition temperature are in each case given by the manufacturer of the orthodontic correction device. The respective critical temperature is, first and foremost, governed by the material or the combination of materials, from which the orthodontic correction device is manufactured. It has emerged that an orthodontic correction device which has already been worn, that is to say which has already changed from the first given shape to the second given shape due to a first activation, and that is now intended to alter its shape at least one further time to a third given shape in order to move a tooth further than previously, can be repeatedly activated. The repeated activation is effected according to the invention at a temperature that preferably lies above body temperature of 37° C. but, in any case, above the critical temperature but below the known glass transition temperature of the orthodontic correction device. That is to say, it has emerged that it is sufficient for a further activation of the orthodontic correction device to heat the latter to a temperature that lies above the critical temperature but below the known glass transition temperature. If the orthodontic correction device is, as previously, heated each time to the glass transition temperature, the material is stressed too much. The lower temperature adjusted for repeated activation also surprisingly reliably produces an alteration from, e.g., the second given shape into a third given shape.

Typical materials for manufacturing orthodontic correction devices are shape memory polymers (SMPs), including both non-crystalline polymers such as, e.g., polyethylene terephthalate glycol (PETG), but also crystalline polymers such as, e.g., thermoplastic polyurethane (TPU). However, acrylic-based polymers, hydrogels or oligomers are also suitable for manufacturing orthodontic correction devices. In addition, films made of SMP are suitable for manufacturing orthodontic correction devices, in particular single-layer films made of thermoformable, stiff polyurethane films that are extruded from the homopolymer of methylene diphenyl isocyanate (MDI) and hexanediol, but also multilayer films, for example, three-layer films having outer layers made of cycloaliphatic polyester and a layer lying inside made of thermoplastic polyether-polyurethane. The outer layers have a glass transition temperature Tg of 90° C. to 120° C. The film thickness is from 0.38 mm to 1.02 mm. Such films are offered, e.g., by BayMaterials under the trade name Zendura® or Zendura FLX®.

According to an advantageous embodiment of the method according to the invention, the temperature, to which the orthodontic correction device is heated during repeated activation, lies by at least 1° C., advantageously at least 2° C., preferably by at least 3° C., 5° C., 10° C. or 15° C. below the known glass transition temperature. Said activation temperature, as explained above, lies above the critical temperature and preferably above body temperature. The lower the temperature for repeated activation is set, the gentler this is for the material of the orthodontic correction device. According to a further preferred embodiment of the method according to the invention, during a further activation of the orthodontic correction device, the temperature is further increased with respect to the temperature of the previous activation, but still lies below the known glass transition temperature. These defaults are also observed if, during the course of the repeated activations, the glass transition temperature of the material of the orthodontic correction device alters, in particular lowers.

A further development of the invention provides that the temperature provided for further activation of the orthodontic correction device is maintained for a predefined time. Said predefined time can, e.g., be at least one minute, but it can also be at least 2 minutes, 5 minutes, 10 minutes, 15 minutes or 30 minutes or longer. The fact that the predefined temperature is held over a predefined time guarantees that the repeated activation, that is to say the desired change, e.g., from the second given shape to the third given shape, is completely achieved.

The method according to the invention optionally provides for heating for a repeated activation by various media. During each heating of the orthodontic correction device, the temperature lies below the known glass transition temperature for the correction device to be treated in each case, but above the critical temperature and, preferably, above body temperature. For example, a liquid medium, in particular water, a salt solution, a solvent or a mixture of at least two of the aforementioned liquid media can be deployed. However, a gaseous medium, in particular hot air or water vapor, can also be deployed. Finally, radiation, in particular from an infrared source or another radiation source that produces heat, can be deployed. It can also prove to be advantageous to apply a combined application of at least two of the aforementioned liquid and gaseous media and radiation. The aforementioned heat sources are in particular suitable for uniform heating of the orthodontic correction device. The deployment of liquid media or the deployment of evaporated liquids, in particular water, which transfer the heat quickly and uniformly to the orthodontic correction device, is particularly preferred.

According to an advantageous embodiment of the method according to the invention, the orthodontic correction device is cooled following the heating and after the heat has been maintained, if applicable, for a predefined time. As a result, the altered shape produced by the repeated activation is quickly fixed and the repeated activation is accelerated with respect to a non-forced cooling to the ambient temperature.

The repeated activation described above of an orthodontic correction device that has already experienced an alteration in shape, in particular because it has already been worn by the patient can, according to a preferred embodiment of the invention, be performed two or multiple times. Since the repeated activation of the orthodontic correction device is effected in a gentle manner, the orthodontic correction device can be deployed for longer and can consequently experience further alterations in shape. As a result, an orthodontic correction device can be utilized for longer, which is more economical.

A repeated activation that is performed two or multiple times is effected, according to an advantageous embodiment of the method, the second time and, if applicable, each following time at a temperature that is in each case equal to or higher than the temperature of the previous activation, but which still lies below the glass transition temperature. The temperature is therefore raised, because it has emerged during experiments that each further alteration in shape requires an increasingly intensive stimulus or an increasingly intensive activation. That is to say, if a higher and higher temperature is adjusted for each following repeated activation, this results in an efficient alteration in shape for the orthodontic correction device and promotes the efficiency of the treatment. If the temperature is left the same during a further activation, the activation is effected over a longer time frame in order to expose the correction device to a more intensive stimulus.

A further advantageous embodiment of the invention provides that the second and, if applicable, each following repeated activation is effected during a predefined time interval. Predefining a defined time interval prior to the next further activation guarantees that the orthodontic correction device leads to the desired altered tooth position. The predefined interval can, e.g., be one day, three or five days, one week or two weeks, but also one month. The predefined time interval is stipulated as a function of the respective treatment, e.g., of the desired movement that one or more teeth are intended to execute due to the action of the correction device.

The method according to the invention is preferably deployed for such orthodontic correction devices that are manufactured from at least one material from the group that comprises a shape memory polymer (SMP), a mixture of shape memory polymers (SMPs), a hydrogel and a shape memory alloy (SMA). However, mixtures of the aforementioned materials can also be contained in the correction devices. The orthodontic correction device can be manufactured as a wire, as a splint or as a metal-reinforced splint made of SMP and/or hydrogel. The method according to the invention is particularly preferably deployed for transparent orthodontic correction devices.

In an advantageous further development of the method according to the invention, a control unit that stores the temperature as well as, optionally, the predefined time for heating and/or the time interval between two repeated activations for at least one further activation and that controls a means for heating is deployed. The control unit that, according to a first alternative, has already stored the temperature and the predefined time for heating as well as, optionally, the time interval between two treatments for a specific material and that, according to a second alternative, stores data input by the user, simplifies the further activation of an orthodontic correction device and, as a result, makes said method safer.

The invention further relates to a device for heating and, therefore, for activating an orthodontic correction device. This is preferably an orthodontic correction device with a known glass transition temperature, which is to be heated to a temperature that preferably lies above body temperature and above the critical temperature but below the known glass transition temperature. However, the device is also suitable for heating other orthodontic correction devices. The device for heating has a receptacle for the orthodontic correction device as well as means for heating. The receptacle for the orthodontic correction device and the means for heating are associated with one another so that the heat emitted by the means for heating is transferred as efficiently as possible to the orthodontic correction device that is supported by the receptacle.

In a simple configuration, the device can be operated by hand for each further heating or activation, for example, by adjusting the means for heating by hand to a desired temperature and stopping them again following heating of the orthodontic correction device. However, the device according to the invention preferably has a control unit that is designed to control the means for heating for at least one further activation, in particular the temperature as well as, optionally, the predefined time for heating and/or the time interval between two repeated activations. As described above, such a control unit makes the further activation of the orthodontic correction device safer and also more uniform and, therefore, gentler for the orthodontic correction device.

The receptacle of the device according to the invention for heating or activation can be embodied in many ways, e.g., as a frame or as a basket, in each case for at least one orthodontic correction device, on or in which the orthodontic correction device is to be arranged for a further activation. A basket that is easy to handle is particularly suitable since the orthodontic correction device for performing the method according to the invention does not, as a general rule, have to take up a specially defined position in the device. The receptacle can be configured as a group of elevations, on or between which the orthodontic correction device can be positioned approximately fixed in place. Said elevations can be approximately bar-shaped, conical or pyramid-shaped. The elevations can be of different heights and different diameters and have different spacings. The elevations are preferably elastic and advantageously have, in particular at the free end, a rounded contour so that the correction device arranged thereon or therebetween is not damaged.

According to an advantageous further development of the invention, the device for heating or activation can have a container for receiving a liquid or gaseous medium or radiation, wherein the receptacle is arranged in the container. The device can comprise, as a container, e.g., a dish that is dimensioned so that the desired number of orthodontic correction devices can be received therein. Typical sizes can be 50 ml cubic capacity, 100 ml, 150 ml, 250 ml or 500 ml cubic capacity. The dish can be produced from any material, e.g., from metal, plastic, glass or ceramic, provided the material withstands the conditions of the method according to the invention.

The device for heating or activation can further have a lid that, in engagement with the container, shuts off the orthodontic correction device with respect to the surroundings. The container and lid can also be utilized for storing the orthodontic correction device. According to a further preferred embodiment, the container and lid are mobile; they can, e.g., be removed from a docking station that comprises, e.g., the control system for the activation including the means for heating. In a simple embodiment, the means for heating, the control system and, if applicable, existing sensors are arranged in the docking station. If the container is removed from the docking station, the wearer of the correction device can then take a lightweight and compact container for storing the correction device with him. However, the container itself advantageously comprises an integrated control system as well as means for heating, for cleaning and/or, if applicable, sensors. In such an embodiment, at least one energy store, mostly a direct current store, is further preferably arranged in the container or in the lid, which energy store stores, e.g., the energy that is required, e.g., for operating sensors or for at least one cleaning operation. In this case, the control unit and the means for heating, the means for cleaning and/or the sensors are likewise arranged in the container or in the lid. Such a transportable embodiment of the device makes the utilizer independent in everyday life or during traveling. If the container is connected to the docking station, all the functions of the unit including the activation are executed, in particular if alternating current is available.

The means for heating can, for example, comprise a heater, in particular an electrically operated heater that heats up a liquid or gaseous medium; however, it can also comprise a radiation source. If the device has a dish, the latter can be utilized for transferring the heat from the means for heating to the liquid or gaseous medium. The device can in particular comprise an infrared source as a radiation source.

The device for heating or activation according to the invention can optionally also comprise a means for cooling that, following the end of the predefined time for heating, cools the orthodontic correction device to the ambient temperature or therebelow in order to fix the shape of the orthodontic correction device altered by the further activation. The cooling of the orthodontic correction device guarantees that the altered shape is securely fixed and that the device is ready to be used again within a short period of time. The means for cooling can be designed for the deployment of gaseous or liquid cooling media, e.g., for the deployment of cold air or cold water.

The device for heating or activation can further optionally comprise means for cleaning the orthodontic correction device, e.g., an ultrasonic source, in particular in conjunction with a liquid medium for heating the orthodontic correction device.

The operation of the device according to the invention for heating or activation is very simplified if the latter comprises, in a preferred further development, a panel for adjusting the control unit and for monitoring the further activation. The panel can comprise means for inputting, which store, e.g., data input by said means in the control unit or that switch the device on or off. However, the panel also advantageously has a display or a screen that displays, e.g., the status of the further activation that is in progress, e.g., the progress of the activation or the remaining time until the device finishes.

Finally, within the framework of an independent inventive solution that can also be operated independently of the manner of the activation of the respective correction device, the device for heating or activating the orthodontic correction device can comprise means for capturing the dwell time of the orthodontic correction device. The presence of the orthodontic correction device is, in this embodiment, captured by sensors and the sensor signals are evaluated and optionally stored in a control unit. All measuring devices that can capture the presence of the correction device in the device for heating are possible as a sensor. A sensor that captures the presence of the correction device by means of electromagnetic waves or the reflection of electromagnetic waves is preferably deployed. A sensor can, e.g., be an optical sensor such as, for example, an infrared sensor or acoustic sensor such as, e.g., an ultrasonic sensor. However, it can also be a contact sensor. It is assumed that the orthodontic correction device is either located in the container or that it is being worn.

The control unit calculates, e.g., the length of time the correction device stays in the device for activation in each case, based on the length of time between two activation steps. An activation step is the time interval between a first and a subsequent activation of the correction device. Moreover, the number of hours or minutes, which the correction device is to be worn for at least in the respective activation step, is stored in the control unit. If, according to the evaluation, the correction device is located for too long in the device, then the orthodontic correction device has accordingly not been worn for long enough in order to produce the desired or calculated modification in the tooth position.

The control unit calculates the difference between the required duration of wearing the correction device and the actual duration of wearing the correction device and stores said difference as missing time for the respective activation step. Wearing the correction device in excess of the time provided for wearing it can also be captured and the time up to the next activation step could be recalculated and shortened. Use can be made of this in exceptional cases if a tooth correction is, e.g., to be effected particularly quickly.

The control unit can, according to a first alternative, recalculate and extend the time frame up to the next activation step itself in order to ensure that the correction device has been worn long enough so that it is guaranteed that the correction device has been worn long enough for the respective activation step in order to bring about the desired tooth movement. According to a second alternative, the control unit can forward this missing time to the laboratory or the dentist looking after the wearer of the correction device such that, if applicable, a recalculation or subsequent calculation of the length of time up to the next activation step is calculated. According to a third alternative, the control unit can forward the missing time to an output unit that displays to the wearer of the correction device that missing time has been captured or how great the missing time is. This information can be displayed as a time indication or as a graphical representation. The output unit can, e.g., be a computer or a tablet screen, or a screen of a mobile phone. The information is preferably displayed within the framework of an application (app) that, if applicable, also displays further information such as, e.g., the fixed date for the next activation or the number of the activations already effected or still outstanding. In this way, the wearer can himself check at any time whether the correction device is being worn for sufficient time or he can optimize the wearing of the correction device. The three alternatives explained above can also be combined. The application can further be designed to capture data or information of the user, e.g., information regarding side effects of wearing the orthodontic correction device such as pain, pressure points or the like. The application can be designed to transmit said data together with the data regarding the length of time the correction device is worn or missing times or with information regarding the activation or cleaning of the correction device to the dentist or the laboratory looking after the utilizer.

According to a preferred embodiment, a threshold is stored in the control unit. The presence of the correction device in the device for heating is, in this embodiment, only stored if the threshold that can be adjusted, e.g., to 10 minutes, 20 minutes or 3o minutes, is exceeded. That is to say, if the correction device is only deposited in the device for heating briefly because the wearer is, e.g., cleaning his teeth or eating something, these short, usual periods of time are not stored by the control unit.

### BRIEF DESCRIPTION OF THE DRAWINGS

Details of the invention are explained below with reference to an exemplary embodiment, wherein:

FIG. 1 shows a first exemplary embodiment of the device according to the invention;

FIG. 2 shows a second exemplary embodiment of the device according to the invention;

FIG. 3 shows a third exemplary embodiment of the device according to the invention;

FIG. 4 shows a flow chart for the optimized calculation of the length of time an orthodontic correction device is worn for.

### DETAILED DESCRIPTION

The exemplary embodiment relates to an orthodontic correction device made of a SMP (alternatively, the correction device is manufactured from a hydrogel or SMA or a combination of at least two of the indicated materials, e.g., from Zendura® or Zendura FLX®). The orthodontic correction device is configured here as a dental splint. However, it can also be configured as a wire that is deployed in retainers on the teeth. A transparent SMP is preferably deployed so that the orthodontic correction device is likewise transparent and therefore inconspicuous during wearing.

The orthodontic correction device alters its shape under the action of an activation or of a stimulus in a first step. Thus, an orthodontic correction device can be manufactured in the future, desired position S4 of the corrected teeth and can be reshaped, prior to being worn for the first time, from the future desired position by the first activation into the shape S1 that corresponds to the current position of the teeth to be corrected. The activation is explained in greater detail below. Said orthodontic correction device is moreover configured so that, as a consequence of further activations, it assumes a shape S2 and, subsequently, S3 and, finally, S4 again, wherein the teeth to be corrected will have moved, for example, by 1 mm to 2 mm when the correction is finished by the shape S4 of the orthodontic correction device. It is expressly noted that the orthodontic correction device can require more or fewer activations depending on how many shapes it can or should assume from the original position of the teeth until it achieves the desired tooth position. In this way, an extensive correction of the tooth position, as a whole, can be achieved incrementally step-by-step by the orthodontic correction device, without the patient experiencing pain due to too great forces being exerted by the orthodontic correction device onto the teeth. At the same time, a relatively major alteration of the tooth position can thus be achieved with a single correction device.

In the case of this exemplary embodiment, it is supposed that the orthodontic correction device is to be worn in one of the shapes S1 to S4 in each case for 2 weeks by a patient, in order to achieve the desired tooth correction. In general, the duration of treatment, that is to say the time during which an orthodontic correction device in a given shape acts on the teeth to be corrected, can last from 5 days up to 3 months, wherein periods of time from one week up to two months are particularly usual.

In each case, after a phase of the treatment has been completed, a further activation of the orthodontic correction device takes place. According to the method according to the invention, the correction device is again subjected to a stimulus or an activation, e.g., by the action of heat, preferably transferred by a liquid medium, in particular water or an aqueous solution. Whilst the first activation according to the prior art per se requires that the orthodontic correction device is heated up to or above the glass transition temperature Tg, it has surprisingly emerged that a first activation can already be effected at a temperature clearly below the glass transition temperature, in this case, for example, at a temperature that lies 15° C. below the glass transition temperature indicated for the correction device to be activated. The further activation, that is to say the second or third or each following activation can be effected at a temperature that lies above the temperature of the first activation, however at least 2° C., but also alternatively at least 5° C., 10° C. or 20° C. below the known glass transition temperature Tg. If, for example, the glass transition temperature of the orthodontic correction device is 75° C., the temperature can be 60° C. for the first activation and can be 65° C. or 70° C. for the further activation. If multiple further activations are performed, the conditions for the further activation can be individually adjusted in the temperature range that lies between the temperature for the first activation and the known glass transition temperature Tg. The temperature is either further raised for an additional further activation, or the conditions can also be intensified by, e.g., holding the temperature at the same level and extending the time of the activation. The following table shows a selection of possible adjustments of temperature and time for the single or repeated activation of orthodontic correction devices:

TABLE 1
Adjustments of temperature and time for the activation of orthodontic
correction devices

| | Known | | | | | |
|---|---|---|---|---|---|---|
| Critical | glass | Temperature/ | Temperature/ | Temperature/ | Temperature/ | Temperature/ |
| temperature | transition | time 1st | time 2nd | time 3rd | time 4th | time 5th |
| Tkrit | temperature Tg | activation | activation | activation | activation | activation |
| [° C.] | [° C.] | [° C./min] | [° C./min] | [° C./min] | [° C./min] | [° C./min] |
| 53 | 60 | 55/15 | — | — | — | — |
| 55 | 65 | 58/10 | 63/15 | — | — | — |
| 58 | 70 | 60/5 | 64/10 | 67/12 | — | — |
| 55 | 75 | 60/10 | 65/10 | 65/20 | 70/15 | — |
| 57 | 75 | 60/12 | 65/12 | 70/15 | 70/30 | 73/20 |

In the case of PETG, a polyethylene terephthalate modified with glycol, or another thermoformable material, the glass transition temperature Tg usually lies between 72° C. and 75° C. For a thermoplastic material, the glass transition temperature Tg can, for example, also lie between 82° C. and 85° C. For numerous thermoplastic materials, the glass transition temperature can, however, also be modified and selectively adjusted, e.g., by deploying chemical components.

The above table clearly shows that the first activation is in each case effected with a temperature below the known glass transition temperature Tg. Said activation produces a modification in shape, the extent of which is predefined. Each further activation, in this case a second to a maximum of a fifth activation, is effected either at an increased temperature or at the same temperature but with a longer activation duration. As a result, it is guaranteed during each activation that a greater stimulus, which produces the next desired modification in shape, is set for the correction device.

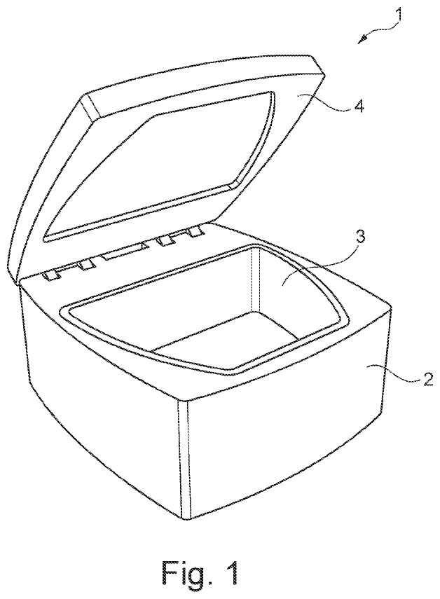

The method of the further activation is preferably performed with the device according to the invention that is depicted, by way of example, in various embodiments in FIGS. 1, 2 and 3. Inasmuch as the devices have the same component parts, they are provided hereinafter with the same reference numerals.

The device 1 in accordance with FIG. 1 has a housing 2 into which a dish 3 is inserted as a receptacle. The dish 3 is, in this case, made of metal, but it can also be manufactured from plastic, glass or ceramic. It has a carrying capacity of 250 ml, but can, if required, be larger or smaller. A dish 3 of this size can receive multiple orthodontic correction devices. Water or an aqueous solution is located in the dish. E.g., cleaning agents, salts, solvents or the like can be added to the aqueous solution, wherein the proportion of water advantageously lies above 50 wt. % based on the total volume of the liquid. The dish 3 is advantageously covered by a lid 4. The housing 2 of the device 1 is preferably thermally insulated.

The orthodontic correction device is either placed directly into the dish 3 or inserted in a basket or frame into the dish 3 so that it is surrounded by the liquid medium or can be flowed around by a gaseous medium or it can be heated uniformly by a radiation source.

The dish 3 is heated by a heat source, preferably an electric heater that is arranged in the housing 2 and not depicted in greater detail in FIG. 1. The heat source has a power that is sufficient to heat the liquid medium to the predefined temperature that lies below the glass transition temperature. Usually, the heat source has a power of 100 W to 500 W. The current can be supplied by direct or alternating current. Alternatively, a heat source can be deployed for water vapor or heated air, wherein water vapor or heated air can then be guided, e.g., through a fan into the dish.

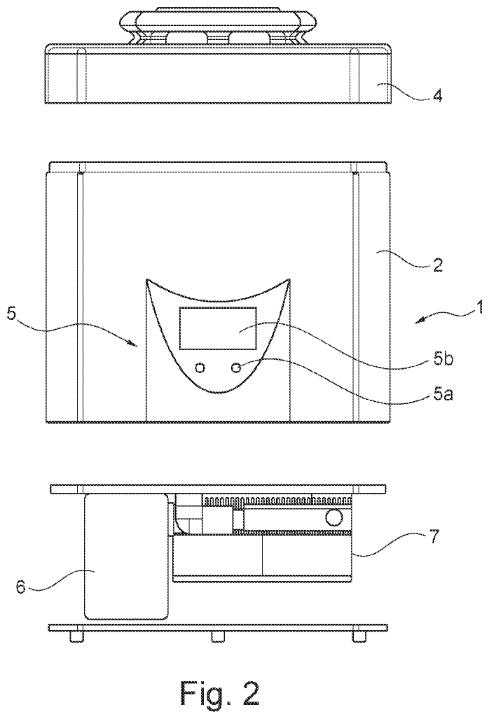

The device 1 according to FIG. 2 has all the features of the embodiment according to FIG. 1. In the housing, it comprises a control unit that is not depicted in greater detail, said control unit comprises a memory and is connected to a panel 5 having an On/Off switch as well as having an input device 5a and display device 5b, and to the means 6 for heating and, if applicable, further component parts that are arranged in or on the housing 2 in order to implement the method according to the invention. The memory of the control unit is either filled with defaults for the temperature that is to be achieved for further activation via the input device 5a of the panel 5, as well as, if applicable, with the time over which the temperature is to be maintained. Alternatively, the memory can be equipped with one or more programs that, in each case predefine, for specific further activations, a temperature and, optionally, a time, over which the predefined temperature is to be maintained. Optionally, the memory can also receive information regarding the spacing of the further activations, regarding cleaning or regarding cooling of the orthodontic correction device and, if applicable, integrate said information into the programs. Whereas experienced technical staff can operate the device directly by using the input device, it is by contrast advisable to save predefined programs in the memory when the patients utilize the device at home. The display device shows, e.g., a selection of input parameters for, for example, the temperature or time, the program or programs available for selection, the status of the device during operation with the display of the temperature and, if applicable, the remaining running time of the further activation.

The device 1, in particular the control unit, can be connected to external means for monitoring and controlling or checking the function of the device, which are not depicted in greater detail here. Thus, the device can be connected to an electronic unit such as a smartphone, a tablet or a computer and can be actuated, monitored, controlled and checked via this. This can be effected by way of special software, e.g., an app. Such an arrangement of the device in conjunction with an electronic unit is in particular sensible such that, e.g., technical staff can monitor or check the deployment of the device by patients. Patients can be informed, e.g., regarding the remaining running time of an activation operation or trigger such an operation, without having to actuate the device themselves.

The device 1 depicted in FIG. 2 has means 7 for cooling arranged in the housing, which cools the orthodontic correction device to the ambient temperature following the further activation. The device can, e.g., be configured so that, following the finish of the further activation, the liquid medium is removed from the dish, e.g., by opening a discharge, and air is subsequently blown through a fan onto the orthodontic correction device. The air can optionally be cooled, but already accelerated air has a cooling effect. In a simple embodiment, the device can also be equipped without means for cooling.

The device 1 optionally further has an ultrasonic source arranged in the housing 3, which is not depicted in greater detail here, that cleans the orthodontic correction device before, during or after the further activation.

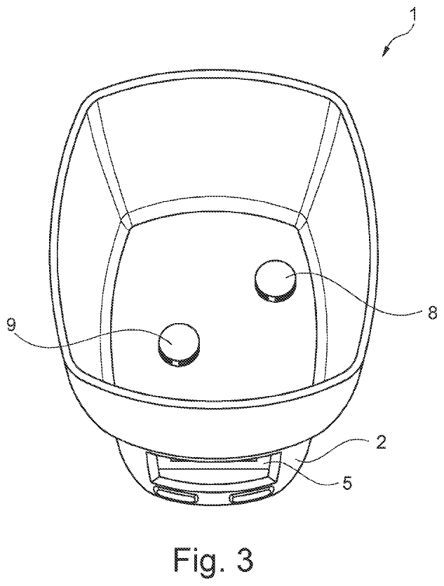

The device 1 shown in FIG. 3 is in particular suitable for use in the professional environment. It comprises—except for the lid 4—all the features of the embodiment in accordance with FIG. 2. The device according to FIG. 3 can have a separate lid. However, at 400 ml, the dish 2 is more capacious than the dishes described above. A discharge 8 for the liquid deployed for heating as well as an inlet 9 for a cooling medium, in this case, e.g., cooled air or cold liquid, is provided at the bottom of the dish. The altered shape of the correction device is quickly fixed by the means for cooling, and the device is ready for the next activation operation, with which a further alteration in shape of an orthodontic correction device is to be produced.

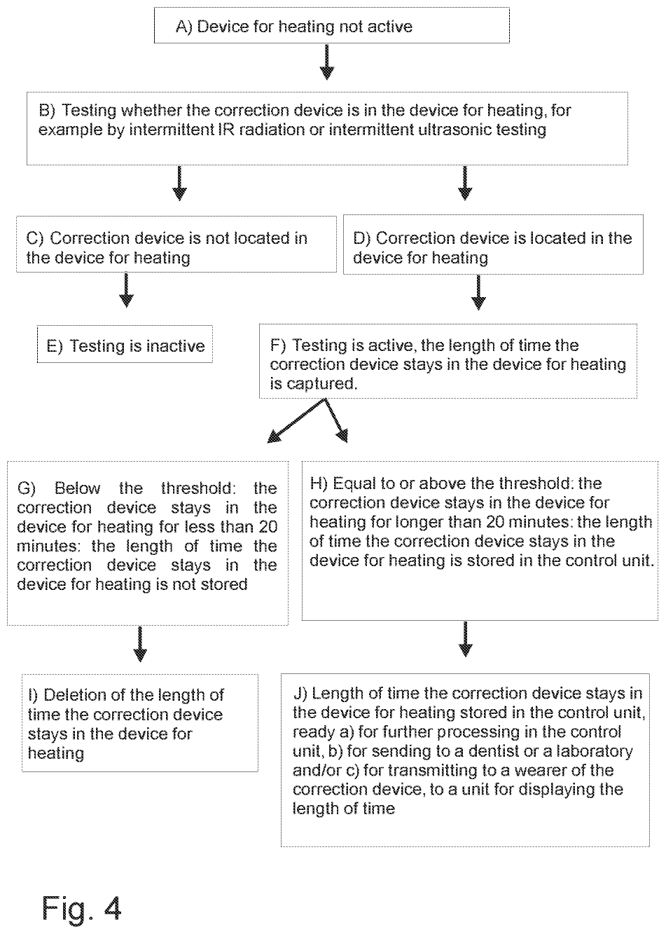

FIG. 4 shows a flow chart that explains the method of operation of means for capturing the dwell time of an orthodontic correction device in a device for heating or activation. The means for capturing comprise, for example, an optical sensor such as an IR sensor that checks the presence of the orthodontic correction device in the device for heating, e.g., by activating the sensor within the interval of seconds or minutes and, in each case, emitting a sensor signal to the control unit, regarding the presence or the absence of the correction device in the device for heating. Alternatively, an ultrasonic sensor or another sensor that can detect the presence or the absence of the correction device can also be deployed.

If no correction device is detected, the monitoring continues running, regularly verifying the presence of the orthodontic correction device. If the correction device is captured in the device for heating, the control unit captures and stores, in each case, the time frame in which the correction device is located in the device for heating and connects this time frame to a predefined length of time. A second length of time that serves as a threshold can optionally be stored in the control unit. If the dwell time frame is shorter than the threshold, said dwell time is not stored and is not included in the subsequent calculations. A threshold can be, e.g., 20 minutes so that, for example, the insertion of the orthodontic correction device into the device for heating or activation during the length of time taken to clean teeth is not stored.

If the dwell time of the correction device in the device for heating is, on the other hand, longer than the length of time of the threshold, or if no threshold is entered, said length of time is captured and stored by the control unit. The control unit can either forward the captured dwell time of the correction device to a laboratory or a dental practice that utilizes said data for the recalculation or subsequent calculation of the length of time up to the next activation of the orthodontic correction device. The control unit can also forward the captured dwell time to a display or output unit that notifies the wearer of the orthodontic correction device how long the correction device has already been worn. The display or output unit can be the device for heating or activation, but it can also be an application (app) that is displayed on the wearer's computer, tablet or mobile phone. Said information can, e.g., also be reproduced in a graphical form that displays what proportion of the period of time for wearing the correction device predefined for the respective activation step has already been achieved. In this way, a tool is made available to the wearer of the correction device, with the aid of which he can optimize his behavior with respect to wearing the correction device.

1. A method for the repeated activation of orthodontic correction devices with a known critical temperature (Tkrit) and a glass transition temperature (Tg) lying above the critical temperature, in which an orthodontic correction device is heated to a temperature that lies above the critical temperature but below the known glass transition temperature.

2. The method according to claim 1, wherein the temperature lies by at least 2° C. below the known glass transition temperature.

3. The method according to claim 1, wherein the temperature is maintained for a predefined time, wherein the predefined time is at least 1 minute.

4. The method according to claim 1, wherein the heating is effected by a liquid medium, by a gaseous medium, by radiation, or hot air or by a combined application of at least two of the aforementioned liquid and gaseous media and radiation.

5. The method according to claim 1, wherein the repeated activation is effected a second time and each following time at a temperature that is in each case higher than the temperature of the previous activation.

6. The method according to claim 1, wherein a second and each following activation is effected at a predefined time interval.

7. The method according to claim 1, wherein the orthodontic correction device is manufactured from at least one material or a mixture of materials from the group that comprises a shape memory polymer, a mixture of shape memory polymers, a hydrogel and a metal or a shape memory alloy.

8. The method according to claim 1, further comprising a control unit that stores the temperature as well as the predefined time for heating and/or the time interval between two repeated activations for at least one further activation and that controls a means for heating.

9. The method according to claim 8, wherein a sensor captures the presence of the orthodontic correction device in a device for heating, and the control unit captures the signals of said sensor.

10. A device for heating an orthodontic correction device with a known critical temperature (Tkrit) and known glass transition temperature to a temperature that lies above the critical temperature and below the known glass transition temperature, comprising a receptacle for the orthodontic correction device as well as means (6) for heating.

11. The device according to claim 10, wherein the device comprises a control unit that is designed to control the means for heating for at least one further activation.

12. The device according to claim 10, wherein the receptacle is a frame or a basket, on or in which the orthodontic correction device is to be arranged for a further activation.

13. The device according to claim 10, wherein the means (6) for heating comprise a heater for a liquid or gaseous medium and/or a radiation source.

14. The device according to claim 10, wherein the device comprises a panel (5) for adjusting the control unit and for monitoring the further activation.

15. The device according to claim 10, wherein the device comprises means for capturing the presence of the orthodontic correction device in the device for heating.

16. The device according to claim 15, wherein the means for capturing the presence of the orthodontic correction device are configured as an optical, acoustic or contact sensor.

17. The method according to claim 4, wherein the liquid medium is water, a salt solution, a solvent or a mixture thereof, wherein the gaseous medium is water vapor, and wherein the radiation is infrared radiation.

18. The device according to claim 11, wherein the control unit is designed to control the temperature and the predefined time for heating and/or the time interval between two repeated activations.
